(19) United States
(12) Patent Application Publication
(10) Pub. No.: US 2001/0046233 A1
(43) Pub. Date: Nov. 29, 2001

(54) Symmetric universal format conversion mechanism with gray code

(76) Inventor: Zhao Wu, San Jose, CA (US)

Correspondence Address: TOWNSEND AND TOWNSEND AND CREW, TWO EMBARCADERO CENTER, EIGHTH FLOOR, SAN FRANCISCO, CA, 94111-3834, US

(21) Appl. No.: 09/865,976

(22) Filed: May 25, 2001

(51) Int. Cl. H04L 12/28; H04L 12/56; H04J 3/16

(52) U.S. Cl. 370/395; 370/466

(57) ABSTRACT

According to the invention, an ATM cell format extender or converter includes a memory and write and read state machines which are symmetric as facilitated by the memory and signals applied to the state machines. The write state machine receives information defining the format of an incoming ATM cell, and, in response, sequences through a first selected state sequence. While in each state of the selected sequence, the write state machine decodes a particular address in memory in which an associated byte of the incoming cell is stored. The read state machine receives information defining the format of an outgoing ATM cell, and, in response, sequences through a second selected state sequence. While in each state of the selected sequence, the read state machine decodes a particular address in the memory from which an associated byte of the outgoing cell is retrieved, thereby to construct the outgoing cell. The read and write state machines are preferably identical. Each of the write and read state machines in a specific embodiment is a 4-bit state machine with 16 Gray encoded states.

### BACKGROUND OF THE INVENTION

The present invention relates to conversion of an asynchronous transfer mode (ATM) cell format and, in particular, to conversion of an ATM cell format with symmetric read and write swizzle logic blocks.

ATM is a well known method of data (e.g., text, video and audio) transfer in the field of communication. A conventional native ATM cell 10, as illustrated in FIG. 1, is a data packet containing 48 bytes of payload and 5 bytes of header (see International Telecommunication Union, Telecommunication Standardization Sector).

A native ATM cell can be modified (i.e., converted or extended) to include additional information of the type not present in the native ATM cell. Such information may include, for example, routing data or performance monitoring data. Depending on the degree of information added, a converted or extended ATM cell may contain, for example, 64 bytes of data.

FIG. 2 illustrates various data bytes of an ATM cell 20 before and after conversion, in accordance with UL3/PL3 specification. The native ATM cell includes 5 bytes forming the cell header, designated in FIG. 2 as bytes H0, H1, H2, H3, HEC (header error checking), and 48 bytes forming the cell payload, designated in FIG. 2 as bytes P0-P47. The converted ATM cell includes: up to 8 bytes of combined prepend and postpend, designated respectively as PRE and POST; the four header bytes H0-H3 of the native ATM cell; up to 4 bytes of combined HEC/UDF; as well as the 48 payload bytes P0-P47 of the native cell. Each of PRE, POST and UDF fields may include a number of user added data, such as, routing or performance monitoring data.

FIG. 2 also illustrates the size dependence of the converted ATM cell in words—each word is 4 bytes—on the sizes of PRE, POST and HEC/UDF fields. For example, when HEC/UDF, PRE and POST are respectively selected to be 0, 2 and 0 words long, the converted ATM cell is 15 words long. Similarly, when HEC/UDF, PRE and POST are respectively selected to be 1, 1 and 1 words long, the converted ATM cell has a length of 16 words.

FIG. 3 illustrates a two-way format conversion of an ATM cell 30 with PRE, POST and HEC lengths of 0, 2 and 1 words, in accordance with a first format, to an ATM cell 32 with PRE, POST and HEC lengths of 0, 2 and 1 words, in accordance with a second format. To convert cell 30 to cell 32, the following operations are carried out: the first word POST of cell 30 is inserted to the beginning of cell 32 to form a 1 word PRE; the 1 word representing HEC in cell 30 is removed, and the second word POST of cell 30 is inserted as the first word POST of cell 32. It is understood that the reverse of the above operations are performed in order to convert the cell format from the second to the first format.

The following patents and publications have come to the attention of the inventor. U.S. Pat. No. 5,341,376, issued to Yamashita, appears to disclose an ATM cell format converter which receives incoming ATM cells each having 53 bytes—which may not be consecutive—from a SONET/SDH frame and, in response, generates outgoing ATM cells each with consecutive 54 bytes and which are transferred to an ATM switch. The patent appears also to disclose a method for synchronization of the write and read operations of the memory in which ATM cell bytes are stored.

U.S. Pat. No. 5,715,249, issued to Miyamoto, also appears to disclose an ATM cell format converter which receives incoming ATM cells each having 53 bytes and, in response, generates outgoing ATM cells each having consecutive 54 bytes. The patent also appears to disclose a method for elimination of possible data corruption that may occur due to the phases of the clock signal applied to the memory during the memory readout operations.

In a publication entitled “Implementation of ATLAS I: A single-chip ATM switch with Backpressure” by Komaros et al., published in August 1998 by “IEEE Hot Interconnects VI Symposium”, the authors evidently disclose an ATM switch incorporating an ATM cell converter which can convert the format of a native 53-byte ATM cell to one having 55 bytes.

Referring to generally known technology, FIG. 4 illustrates a simplified block diagram of a prior art ATM cell format converter 40 (hereinafter referred to as cell format converter). Cell format converter 40 includes a write logic swizzle logic 42, a two-port random access memory (RAM) or register file (herein after collectively referred to as RAM) 44 and a read swizzle logic 46. Write swizzle logic 42 receives information about the lengths of PRE, POST and HEC fields both of the native ATM cell—the incoming cell—as well as those of the ATM cell after the conversion—the outgoing cell. Write swizzle logic 42 decodes corresponding address locations in the memory address space of RAM 44 in which associated bytes of the outgoing cell are stored, in accordance with the desired cell format. Subsequently, read swizzle logic 46, knowing such decoded address locations, in an orderly fashion retrieves data stored in RAM 44 so as to form the outgoing cell. Consequently, in cell format converter 40, cell format conversion is carried out by write swizzle logic 42.

In FIG. 4, signals Wprelen, Wpostlen, Wheclen—which are respectively 2 bits, 2 bits and 1 bit wide—represent the sizes (i.e., lengths) of PRE, POST and HEC of the incoming cell. Signals Rprelen, Rpostlen, Rheclen—which are respectively 2 bits, 2 bits and 1 bit wide—represent the sizes of PRE, POST and HEC of the outgoing ATM cell. Signal Wrequest and Rrequest, respectively enable or disable write swizzle logic 42 and read swizzle logic 46; signals Wenb and Renb respectively enable or disable the write and read operations of RAM 44; and signals Wdata and Rdata respectively carry the various bytes of the incoming and outgoing ATM cells. Since write swizzle logic 42—which carries out the cell format conversion—receives signals identifying formats of both incoming as well as outgoing cells, while read swizzle logic 46 receive signals identifying only the format of the outgoing cells, cell format converter 40 has asymmetric write and read swizzle logic.

FIG. 5 shows a simplified block diagram of another prior art ATM cell format converter 50. In cell format converter 50, write swizzle logic 52 writes various bytes of the incoming ATM cells to RAM 54. Thereafter, read swizzle logic 56, retrieves the associated stored bytes, in accordance with the desired outgoing cell format, so as to form the outgoing ATM cell. Consequently, in cell format converter 50, read swizzle logic 56 carries out the cell format conversion. Read swizzle logic 56 receives signals which define the format of an incoming cell—signals Wprelen, Wpostlen, Wheclen—as well as signals which define the format of an outgoing cell—signals Rprelen, Rpostlen, Rheclen, while write swizzle logic 52 receives signals defining the format of the incoming cells. Therefore, in cell format converter 50 read swizzle signal 56 and write swizzle logic 52 are also asymmetric. The asymmetry in write and read swizzle logic of cell format converters 40 and 50 results in a number of drawbacks.

First, because of the asymmetry of such conventional cell format converters, the swizzle logic carrying out the format conversion (i.e., write logic in FIG. 4, and read logic in FIG. 5) requires a large number of transitions in the state machine, thereby resulting in a large number of gates in the swizzle logic. Moreover, due to their asymmetry, conventional cell format converters 40 and 50 are difficult to synthesize with commercially available logic synthesize tools to achieve high clock speeds.

A second major drawback of cell converters 40 and 50 is their inability to dynamically change the cell formats of incoming ATM cell streams without corrupting at least parts of such streams—an effect referred to in the art as hitless format change. Cell format converters 40 does not provide hitless cell format conversion insofar as the write swizzle logic 42 also receives and depends on the read signals that are applied to read swizzle logic 46. Similarly, cell converter 50 does not provide hitless cell format conversion insofar as the read swizzle logic 56 also receives and depends on the write signals that are applied to write swizzle logic 52.

### BRIEF SUMMARY OF THE INVENTION

According to the invention, an ATM cell format extender or converter includes a memory and write and read state machines which are symmetric as facilitated by the memory and signals applied to the state machines. The write state machine receives information defining the format of an incoming ATM cell, and, in response, sequences through a first selected state sequence. While in each state of the selected sequence, the write state machine generates a particular address in memory in which an associated byte/word of the incoming cell is stored. The read state machine receives information defining the format of an outgoing ATM cell, and, in response, sequences through a second selected state sequence. While in each state of the selected sequence, the read state machine generates a particular address in the memory from which an associated byte/word of the outgoing cell is retrieved, thereby to construct the outgoing cell. The read and write state machines are preferably identical. Each of the write and read state machines in a specific embodiment is a 4-bit state machine with 16 Gray encoded states.

A data cell format converter, in accordance with one embodiment of the present invention, includes write and read swizzle logic blocks—which are symmetric—as well as a memory which stores and supplies the data bytes disposed in the cell.

In operation, the write swizzle logic block receives a number of logic signals defining the lengths of the prepend, postpend and header error checking (HEC) fields of the cell before the conversion (i.e., incoming cell). The write swizzle logic block receives a number of logic signals defining the lengths of the prepend, postpend and HEC fields of the cell after the conversion (i.e., outgoing cell). The write swizzle logic decodes and stores in the decoded addresses of the memory, associated bytes of the incoming cell, in accordance with prepend, postpend and HEC lengths of the incoming cell. Subsequently, the read swizzle logic decodes and retrieves from the decoded addresses of the memory associated bytes of the outgoing cell, in accordance with prepend, postpend and HEC lengths of the outgoing cell, which is thus extended or converted.

Each of write and read swizzle logic blocks, in accordance with one embodiment of the present invention, is a state machine with Gray encoded states. The write state machine stores associated bytes of the incoming cells in the memory in accordance with one of a predefined sequence of states. The sequence of states which the write state machine transitions thorough is defined by the lengths of the prepend, postpend and HEC of the incoming cell. While in each state, the write state machine generates an output signal which decodes an address in the memory to which a word (i.e., four bytes) of the incoming cell is written. The state machine binary output signal at each state is the same as the Gray encoding of that state.

After the associated bytes of the incoming cell are stored in the memory, the read state machine begins to retrieve the stored data from the memory in accordance with one of a predefined sequence of states. The sequence of states which the read state machine transitions through is defined by the lengths of the prepend, postpend and HEC fields of the outgoing cell. The write and read state machines have the same state transition tables and thus sequence through the same sequence of states in the event the incoming and outgoing cells have the same format.

In some embodiments, each of write and read state machines is a 4-bit state machine with 12 different state sequences each corresponding to one of 12 different cell formats. Depending on the size of prepend, postpend and HEC, a state sequence may have up to 16 state transitions. The memory is a 32-bit wide dual port static ram or a register file. Each word of the incoming cell is stored in and fetched from a different one of the address locations of the memory.

Since the read and write state machines are identical and thus symmetric, the cell format converter has fewer logic gates than those of the prior art. Furthermore, to the extent that the various words of both incoming and outgoing cells are stored in and subsequently retrieved from predetermined locations of the memory and in accordance with predefined state sequences, changes made to the format of the incoming or outgoing cells while cell conversion is taking place does not result in data corruption. In other words, if a change in the format of either the incoming or outgoing cell occurs, while a cell format conversion in accordance with an earlier format is in process, since the read and the write state machines are symmetric and always store and retrieve associated words of a cell from the same locations of the memory, no data is corrupted when a new cell conforming to the new format is being formed. Consequently, the cell format converter of the present invention is a hitless cell format converter.

### BRIEF DESCRIPTION OF THE DRAWINGS

FIG. 1 illustrates a native ATM cell packet, as known in the prior art.

FIG. 2 illustrates the size dependence of a converted ATM cell on the selected sizes of its prepend, postpend and header fields, as known in the prior art.

FIG. 3 illustrates an example of various fields of an ATM cell before and after a two-way format conversion, as known in the prior art.

FIG. 4 illustrates a simplified logic block diagram of a conventional ATM cell format converter, as known in the prior art.

FIG. 5 illustrates a simplified logic block diagram of another conventional ATM cell format converter, as known in the prior art.

FIG. 6 illustrates a simplified logic block diagram of an ATM cell format converter in accordance with one embodiment of the present invention.

FIG. 7 illustrates a state transition diagram of write and read state machines of the cell format converter of FIG. 6 in accordance with one embodiment of the present invention.

FIG. 8 illustrates an example of an ATM cell format conversion by the ATM cell converter of FIG. 6 in accordance with one embodiment of the present invention.

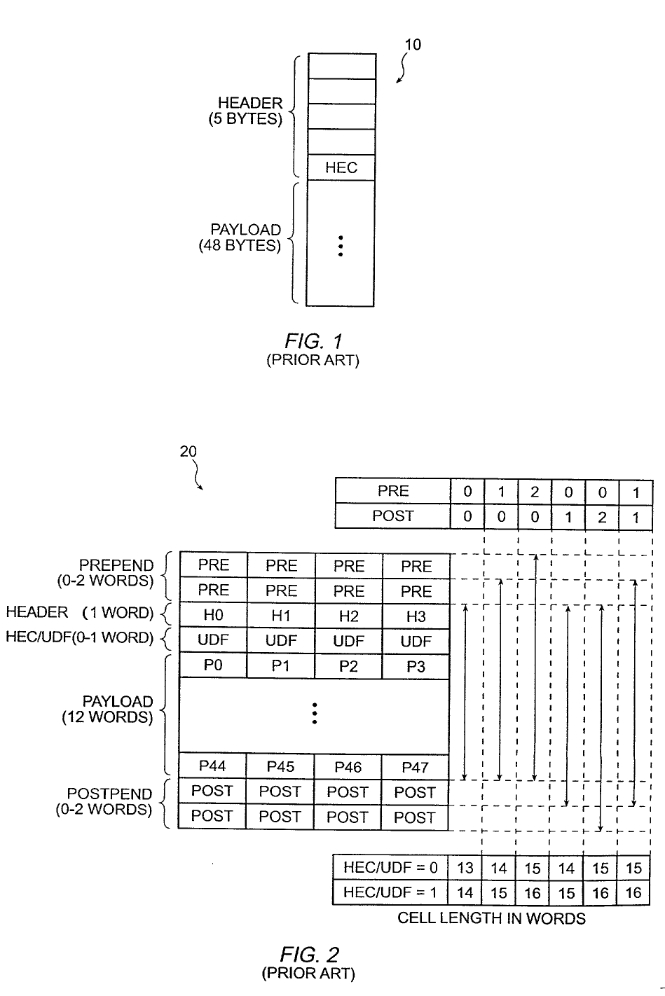

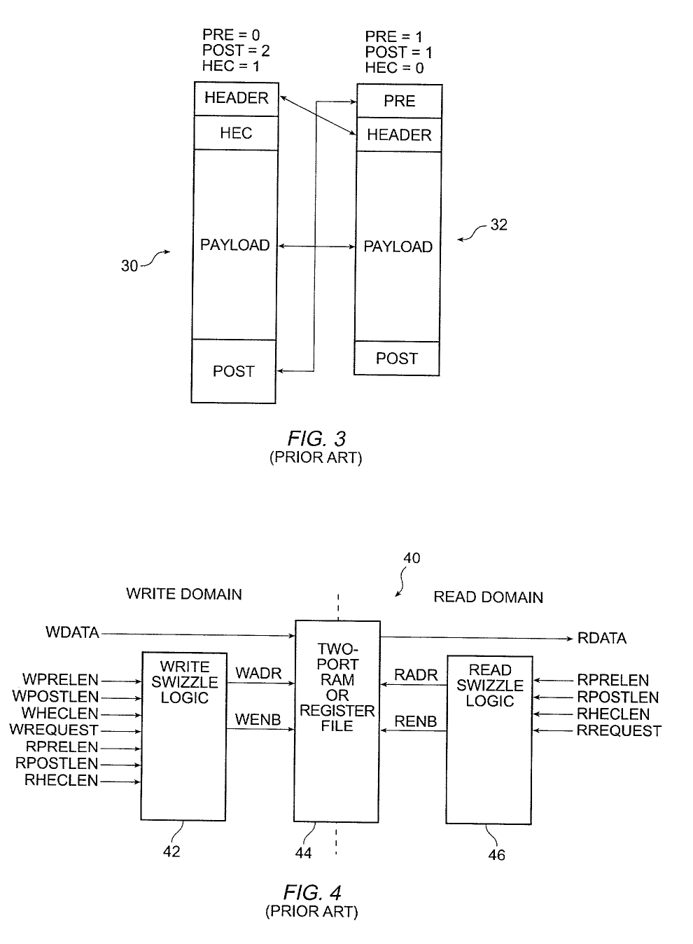

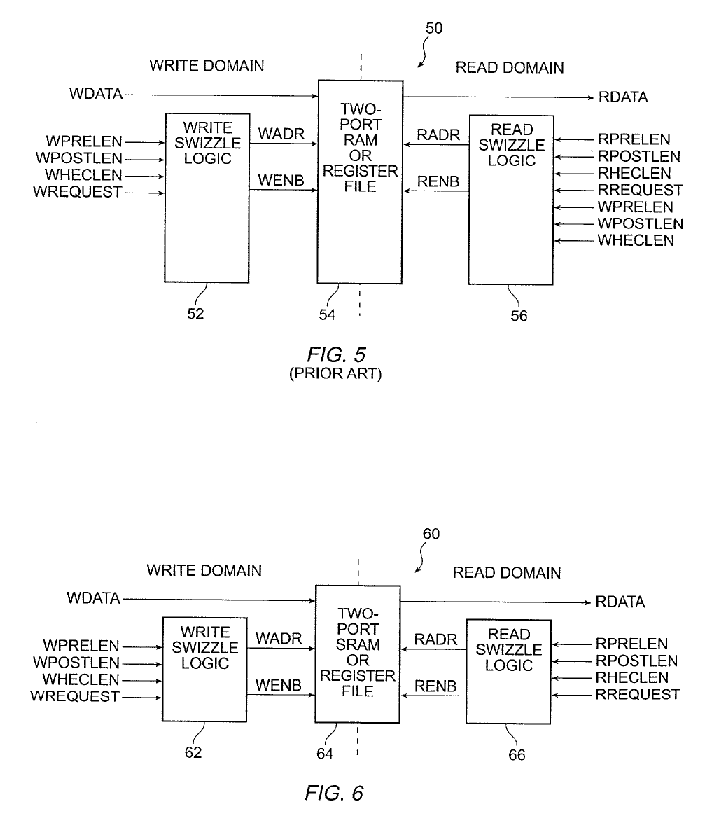

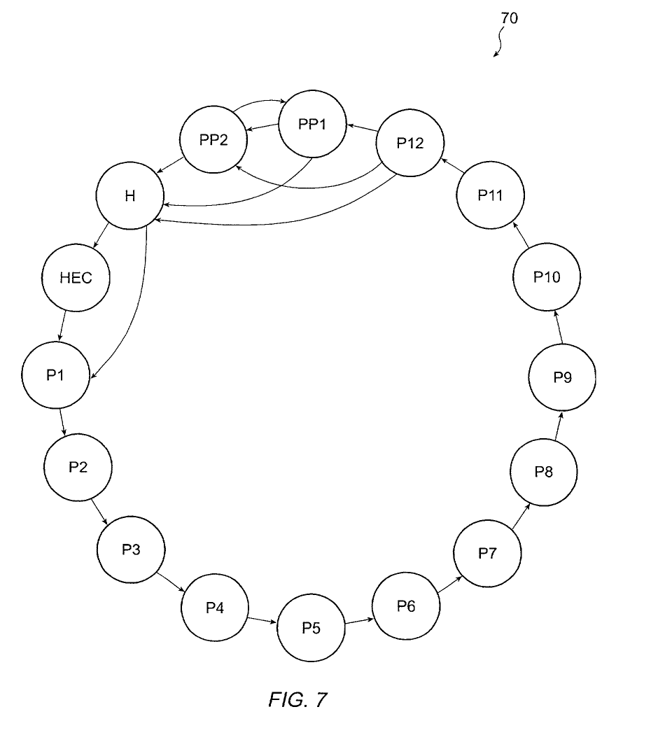

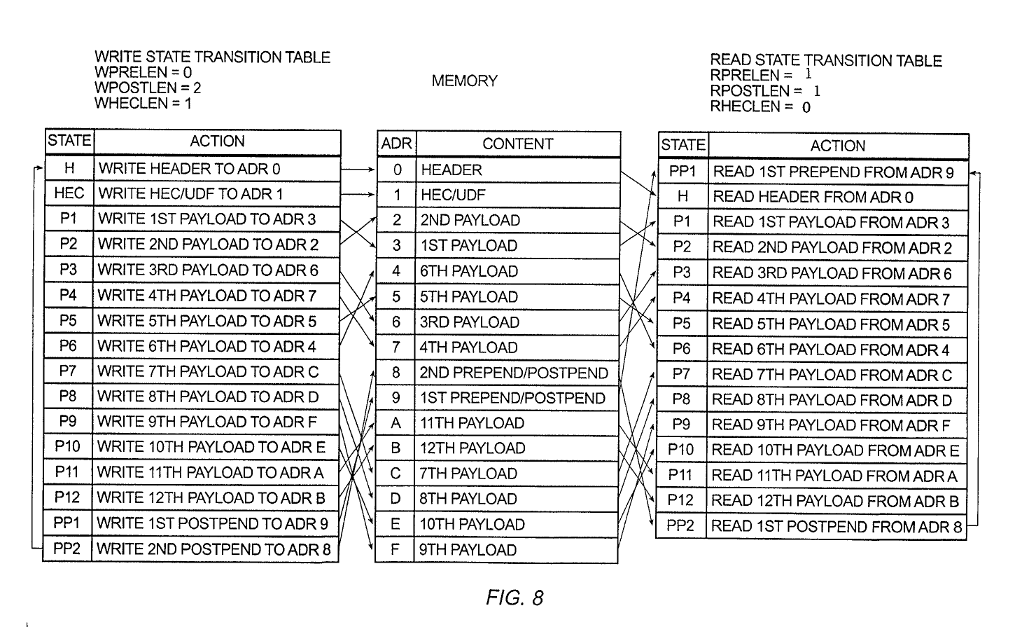

### DETAILED DESCRIPTION OF THE INVENTION

FIG. 6 illustrates a simplified logic block diagram of an ATM cell format converter 60 in accordance with one embodiment of the present invention. ATM cell format converter 60 includes a write swizzle logic 62, a two port static random access memory (SRAM) or register file (hereinbelow referred to collectively as memory) 64, and a read swizzle logic 66.

Write swizzle logic 62 receives four logic signals, namely Wprelen, Wpostlen, Wheclen and Wrequest and, in response, generates two logic signals Wadr and Wenb. Wprelen is a 2-bit logic signal which defines the length (i.e., the number of bytes) of the prepend of an ATM cell received by cell format convert 60 and undergoing format conversion (hereinafter referred to as incoming cell). Wpostlen is a 2-bit logic signal which defines the length of the postpend of an incoming ATM cell. It is understood that prepend and postpend are data bytes respectively appended to the beginning and the end of an ATM cell. Signal Wheclen is a 1-bit logic signal defining the length of the header error checking (HEC) field disposed in the header section of an incoming ATM cell. Wrequest is a 1-bit logic signal which, depending on its logic level, either enables or disables write swizzle logic 62. Output logic signal Wadr is 4 bits wide and decodes address locations within the memory address space of memory 64 in which associated bytes of the incoming ATM cells are stored. Output logic signal Wenb is 1 bit wide which, depending on its logic level, either enables or disables the writing of data to memory 64.

Read swizzle logic 62 receives four logic signals, namely Rprelen, Rpostlen, Rheclen and Rrequest and, in response, generates two logic signals Radr and Renb. Rprelen is a 2-bit logic signal defining the length of the prepend of an ATM cell which has undergone format conversion (hereinafter referred to as outgoing cell) by cell format converter 60. Rpostlen is a 2-bit logic signal which defines the length of the postpend of an outgoing ATM cell. Signal Rheclen is a 1-bit logic signal defining the length of the HEC of an outgoing ATM cell. Rrequest is a 1-bit logic signal which, depending on its logic level, either enables or disables read swizzle logic 62. Output logic signal Radr is 4 bits wide and decodes address locations within the memory address space of memory 64 from which associated bytes of the outgoing ATM cells are retrieved. Output logic signal Renb is 1-bit wide which, depending on its logic level, either enables or disables the reading of data from memory 64.

As seen from FIG. 6, write swizzle logic 62 does not receive any of the signals that are applied to read swizzle logic 66, and read swizzle logic 66 does not receive any of the signals that are applied to write swizzle logic 62. Accordingly, write swizzle logic 62 and read swizzle logic 66 of cell format convert 60 are symmetric.

Logic signal Wdata is 32 bits wide and carries the multiple bytes of an incoming ATM cell written to memory 64. Logic signal Rdata is 32-bits wide and carries the multiple bytes of an outgoing ATM cell retrieved from memory 64.

Each of write swizzle logic 62 and read swizzle logic 66 is a state machine with identical state transition tables and state diagrams. Table I below lists for each possible combination of prepend, postpend and HEC word lengths, an associated state sequence carried out by the state machines of write and read swizzle logic blocks 62 and 66.

TABLE I

| Prepend | Postpend | HEC | State sequence |
|---|---|---|---|
| 0 | 0 | 0 | H,p1,p2,p3,p4,p5,p6,p7,p8,p9,p10,p11,p12 |
| 0 | 0 | 1 | H,HEC,p1,p2,p3,p4,p5,p6,p7,p8,p9,p10,p11,p12 |
| 0 | 1 | 0 | H,P1,p2,p3,p4,p5,p6,p7,p8,p9,p10,p11,p12,pp1 |
| 0 | 1 | 1 | H,HEC,p1,p2,p3,p4,p5,p6,p7,p8,p9,p10,p11,p12,pp1 |
| 0 | 2 | 0 | H,p1,p2,p3,p4,p5,p6,p7,p8,p9,p10,p11,p12,pp1,pp2 |
| 0 | 2 | 1 | H,HEC,p1,p2,p3,p4,p5,p6,p7,p8,p9,p10,p11,p12,pp1,pp2 |
| 1 | 0 | 0 | pp1,H,p1,p2,p3,p4,p5,p6,p7,p8,p9,p10,p11,p12 |
| 1 | 0 | 1 | pp1,H,HEC,p1,p2,p3,p4,p5,p6,p7,pS,p9,p10,p11,p12 |
| 1 | 1 | 0 | pp1,H,p1,p2,p3,p4,pS,p6,p7,p8,p9,p10,p11,p12,pp2 |
| 1 | 1 | 1 | pp1,H,HEC,p1,p2,p3,p4,p5,p6,p7,p8,p9,p10,p11,p12,pp2 |
| 2 | 0 | 0 | pp1,pp2,H,p1,p2,p3,p4,p5,p6,p7,p8,p9,p10,p11,p12 |
| 2 | 0 | 1 | pp1,pp2,H,HEC,p1,p2,p3,p4,p5,p6,p7,p8,p9,p10,p11,p12 |

The input signals applied to the write state machine are Wprelen, Wpostlen and Wheclen. The input signals applied to the read state machines are Rprelen, Rpostlen and Rheclen. It is thus understood that when applied to the write state machine, input signals Prepend, Postpend and HEC of state Table I respectively correspond to signals Wprelen, Wpostlen and Wheclen of FIG. 6. It is also understood that when applied to the read state machine, input signals Prepend, Postpend and HEC of state Table I, respectively correspond to signals Rprelen, Rpostlen and Rheclen of FIG. 6. Each of write and read state machines has 16 states corresponding to 12 different input signals combinations each having an associated state transition sequence.

When applied to the write state machine, the 12 states p1-p12 are associated with the payload words of an incoming ATM cell. For example, state p1 corresponds to the first payload word of an incoming ATM cell; state p7 corresponds to the 7^{th} payload word of an incoming ATM cell. Consequently, each of states p1-p12 is associated with a different one of the 12 payload words of an incoming ATM cell. States H and HEC/UDF, are respectively associated with the header and HEC/fUDF words of an incoming ATM cell. States pp1 and pp2 are associated with prepend and postpend words of an incoming ATM cell.

When applied to the read state machine, the 12 states p1-p12 are associated with the payload words of an outgoing ATM cell. It is understood that each of states p1-p12 is associated with a different one of the 12 payload words of an outgoing ATM cell. The States H and HEC, are respectively associated with the header and HEC/UDF words of an outgoing ATM cell. The states pp1 and pp2 are associated with prepend and postpend words of an outgoing ATM cell.

For example, in accordance with Table I, if prepend, postpend and HEC of an incoming (or an outgoing) ATM cell are all 0 bytes in length, the state machine of write swizzle logic 62 (or that of the read swizzle logic 66) goes through the state sequences H, p1, p2, p3, p4, p5, p6, p7, p8, p9, p10, p11, p12. As another example, if prepend, postpend and HEC of the outgoing (or an incoming) cell have respective lengths of 0, 2 and 1 words, the state machine of read swizzle logic 66 (or that of the write swizzle logic 62) goes through the state sequence H, HEC, p1, p2, p3, p4, p5, p6, p7, p8, p9, p10, p11, p12, pp1 and pp2.

Consequently, cell format converter 60 of the present invention may convert a cell with a format corresponding to any of the input combinations of Table I to a cell having a format corresponding to any other input combination of Table I. Alternatively, when the input signals applied to the read and write state machine are selected to be the same, no cell format conversion takes place and thus the outgoing cell and the incoming cell will have the same format.

Write swizzle logic 62 and read swizzle logic 66 each is a 4-bit state machine to accommodate the 16 different states of state Table I—or state diagram 70. To minimize the number of logic level transitions and thus reduce the power consumption, the 16 different states of Table I are Gray encoded. Table II below, is a Gray encoding of the 16 states of the read and write state machines. The second and third columns of Table II, respectively display the Gray-encoded states of the read and write state machines in binary and Hexadecimal (hex) notations. The Gray encoded states are also the state machine output signals decoding the addresses in memory 64 to which various words of an ATM cell are written by the write state machine and subsequently retrieved by the read state machine.

TABLE II

| State | Gray Encoding in binary format | Gray Encoding in hex format |
|---|---|---|
| H | 0000 | 0 |
| HEC | 0001 | 1 |
| p1 | 0011 | 3 |
| p2 | 0010 | 2 |
| p3 | 0110 | 6 |
| p4 | 0111 | 7 |
| p5 | 0101 | 5 |
| p6 | 0100 | 4 |
| p7 | 1100 | C |
| p8 | 1101 | D |
| p9 | 1111 | F |
| p10 | 1110 | B |
| p11 | 1010 | A |
| p12 | 1011 | B |
| Pp1 | 1001 | 9 |
| Pp2 | 1000 | 8 |

To convert a cell format, the write state machine of write swizzle logic 62—based on the binary value of signals Wprelen, Wpostlen and Wheclen—performs a state transition sequence, in accordance with Tables I and II. While in each state, the write state machine stores an associated word of an incoming cell in a different address location of memory 64. For example, if the write state machine is in state 0, the write state machine stores the header word H of the incoming ATM cell to the location address 0 of memory 64; if the write state machine is in state 7, the write state machine stores the word corresponding to the 4^{th} payload word p4 of the incoming ATM cell to location address 7 of memory 64. The format of an incoming cell—which defines the particular state sequence that the write state machine travels through—is supplied to the write state machine via signals Wprelen, Wpostlen and Wheclen.

After the write state machine stores the associated bytes of an incoming cell, in accordance with one of the 12 state sequences of Table I, the read state machine is enabled to form the outgoing cell, as described below.

To form an outgoing cell, the read state machine of read swizzle logic 66,—based on the binary value of signals Rprelen, Rpostlen and Rheclen—performs a state transition sequence, in accordance with Tables I and II. While in each state, the read state machine retrieves an associated word of the outgoing cell from a different address location of memory 64. For example, if the read state machine is in state F, the read state machine reads the 9^{th} payload word p9 of the ATM cell from the location address F of memory 64. The format of an outgoing cell—which defines the particular state sequence that the read state machine travels through—is supplied to the read state machine via signals Rprelen, Rpostlen and Rheclen.

Once the read state machine cycles through the last of the states of the selected state sequence, the last words of the outgoing cell is retrieved from the memory. The state sequence, and accordingly, the retrieved data are so ordered as to have the desired cell format.

By way of an example, the operation of cell converter 60 is described below. Assume that cell converter 60 is to convert an ATM cell format with prepend, postpend and HEC lengths of 0, 2 and 1 words, respectively, to an ATM cell format with prepend, postpend and HEC lengths of 1, 1 and 0 words, respectively. FIG. 8 illustrates a write state transition table, a memory, and a read state transition table, in accordance with the above example.

The write state transition table includes 16 states. Each state is associated with a word of an incoming ATM cell and an address in memory 64 in which the associated word is written during that state. The 16 states of the write state machine are defined by lengths of Wprelen, Wpostlen and Wheclen—which are shown to be respectively 0, 2 and 1 words long. Designated with each state in the write state transition table is an arrow pointing from that state to a particular location in the memory in which the word associated with that state is stored.

The read state transition table includes 15 states. Each state is associated with a word of an outgoing ATM cell and an address in memory 64 from which the associated word is retrieved during that state. The 15 states of the read state machine are defined by lengths of Rprelen, Rpostlen and Rheclen—which are shown to be respectively 1, 1 and 0 words long. Designated with each state in the read state transition table is an arrow pointing from a corresponding location in the memory from which the word associated with that state is retrieved. As seen in state Table I, the state transition sequence for an incoming cell with prepend, postpend and HEC lengths of 0, 2 and 1 bytes is H, HEC, p1, p2, p3, p4, p5, p6, p7, p8, p9, p10, p11, p12, pp1, pp2. Accordingly, the write state machine goes through states 0, 1, 3, 2, 6, 7, 5, 4, C, D, F, E, A, B, 9 and 8 (see the Gray encoding of FIG. 8) sequentially and stores in each of the following decoded addresses an associated word of the cell, as shown in the table below.

| Memory 64 location address | Stored word |
|---|---|
| 0 | H |
| 1 | HE/UDF |
| 3 | 1^{st} payload |
| 2 | 2^{nd} payload |
| 6 | 3^{rd} payload |
| 7 | 4^{th} payload |
| 5 | 5^{th} payload |
| 4 | 6^{th} payload |
| C | 7^{th} payload |
| D | 8^{th} payload |
| F | 9^{th} payload |
| E | 10^{th} payload |
| A | 11^{th} payload |
| B | 12^{th} payload |
| 9 | 1^{st} prepend/postpend |
| 8 | 2^{nd} prepend/postpend |

Next, the read state machine reads out the stored words from memory to construct a new ATM cell. As seen from Table I, when prepend, postpend and HEC are selected to have 1, 1 and 0 bytes respectively, the read state machine goes through the sequence pp1, H, p1, p2, p3, p4, p5, p6, p7, p8, p9, p10, p11, p12 and pp2, which, as described above, in Gary code correspond to states hex 9, 0, 3, 2, 6, 7, 5, 4, C, D, F, E, A, B and 8. The sequence of memory addresses decoded by the read state machine and the words retrieved from the decoded addresses are shown in the following table:

| Memory 64 location address | Retrieved word |
|---|---|
| 9 | 1^{st} prep end |
| 0 | H |
| 3 | 1^{st} payload |
| 2 | 2^{nd} payload |
| 6 | 3^{rd} payload |
| 7 | 4^{th} payload |
| 5 | 5^{th} payload |
| 4 | 6^{th} payload |
| C | 7^{th} payload |
| D | 8^{th} payload |
| F | 9^{th} payload |
| E | 10^{th} payload |
| A | 11^{th} payload |
| B | 12^{th} payload |
| 8 | 1^{st} postpend |

Consequently, once the sizes of prepend, postpend and HEC of both incoming and outgoing cell are determined, the following sequence of events occur. First, the write state machine begins transition through a particular sequence of states—as defined by the sizes of the incoming cells' associated prepend, postpend and HEC—as illustrated in Table I. While in each state of the sequence, the write state machine stores an associated word of the cell to a corresponding address in memory 64. Thereafter, the read state machine begins to transition through a particular sequence of states—as defined by the sizes of the outgoing cell' associated prepend, postpend and HEC fields—as illustrated in Table I. While in each state of the sequence, the read state machine retrieves an associated word of the cell from a corresponding address in memory 64 to form an outgoing cell.

As stated above, the read and write state machines are identical and the write and read swizzle logic blocks are symmetric—the write swizzle logic does not receive any of the signals applied to the read swizzle logic and vice versa. The symmetry reduces the degree of complexity involved in the design of the write and read state machines. The similarity of the state machines enables one to instantiate the same physical design of the state machine twice, once for the write swizzle logic and once for the read swizzle logic. It is understood that many of the commercially available logic behavioral programming languages (e.g., Verilog or VHDL) and logic synthesis tools may be used to design the write and read state machines of the present invention.

To the extent that the various words disposed in the incoming and outgoing ATM cells are written to and subsequently retrieved from predetermined locations within memory 64, changes made to the format of the incoming or outgoing cells while a cell format conversion is taking place does not corrupt the data. For example, as seen from the state encoding Table II, the write state machine always writes the header field H of an incoming ATM cell to address location 0 of memory 64; similarly the write state machine always writes the fourth payload word p4 of the incoming cell to address location 7 of memory 64. Moreover, the read state machine always reads the header field H of the outgoing cell from address location 0 of memory 64; similarly the read state machine always reads the fourth payload word p4 of the outgoing ATM cell from address location 7 of memory 64. Accordingly, if a change in the format of an incoming or outgoing cell occurs, while a cell format conversion in accordance with an earlier format is in process, since the write and read state machines are symmetric and, moreover, respectively store and retrieve associated words of an ATM cell from the same locations of memory 64, no data is corrupted when a new cell conforming to a new format is formed.

To the extent that the write and read swizzle logic circuit blocks 62 and 66 are symmetric, as described above, the write and read state machines of the present invention require fewer logic stages than those known in the prior art and thus operate at higher clock speeds.

The specific embodiments of the present invention described above are illustrative and not limitative and various modifications, alterations, alternative constructions, and equivalents thereof are also encompassed within the scope of the invention.

The invention is not limited by the binary encoding, Gray or otherwise, of the various states of the read and write state machines. The invention is not limited by the number of bytes in either the payload or header of an incoming or outgoing cell. Furthermore, the invention is not limited by the format of the incoming or outgoing cell. Nor is the invention limited by the width of the bus carrying various words of incoming or outgoing cells. The invention is not limited by the number of bytes in a word. Moreover, the bus width and the word size may or may not be the same.

The invention is not limited by the type of memory or register file that stores various bytes of the incoming cells. Nor is the invention limited by the particular manufacturing technology, CMOS or otherwise, that is used to fabricate the cell format converter of the present invention.

The invention is not limited to converting the format of ATM cells and may be used to convert the format of any data packet carrying multiple bytes of data.

Additions, subtractions, deletions, and other modifications and changes to the present invention may be made thereto without departing from the scope of the present invention as is set forth in the appended claims.

What is claimed is:

1. An apparatus for converting a cell format from a first format to a second format, the cell including a plurality of data bytes, the circuitry comprising:
memory;
write circuitry which is operative to receive a plurality of signals and stores the plurality of data bytes of the cell in the memory in accordance with the first format; and
read circuitry which is operative to receive a second plurality of signals and retrieve associated bytes of the stored plurality of the data bytes of the cell from the memory in accordance with the second format; wherein
the first plurality of signals do not include any of the second plurality of signals; and wherein
the second plurality of signals do not include any of the first plurality of signals.

2. The apparatus of claim 1 wherein each of the write circuitry and the read circuitry is a state machine.

3. The apparatus of claim 2 wherein the state machines of the write circuitry and the read circuitry provide identical state transitions.

4. The apparatus of claim 3 wherein the states of each of the write and the read state machines are Gray encoded.

5. The apparatus of claim 4 wherein each successive n bytes of the cell is stored in a different address location of the memory, wherein n is an integer varying between 1 and 32.

6. The apparatus of claim 5 wherein n is 4.

7. The apparatus of claim 6 wherein the write state machine is further operative to receive logic signals defining lengths of prepend, postpend and HEC fields of the first format of the cell.

8. The apparatus of claim 7 wherein the read state machine is further operative to receive logic signals defining lengths of prepend, postpend and HEC fields of the second format of the cell.

9. The apparatus of claim 8 wherein the lengths of prepend, postpend and HEC fields of the first format of the cell define the sequence of state transitions of the write state machine.

10. The apparatus of claim 9 wherein the lengths of prepend, postpend and HEC fields of the second format of the cell define the sequence of state transitions of the read state machine.

11. The apparatus of claim 10 wherein the write state machine and the read state machine transition through the same sequence of states if the lengths of prepend, postpend and HEC fields of the first and second format of the cell are the same.

12. The apparatus of claim 11 wherein the sum of the lengths of the prepend and postpend fields in each of the first and second cell formats is up to 2 words and the length of the HEC field in each of the first and second cell formats is up to 1 word.

13. The apparatus of claim 12 wherein each of the write state machine and read state machine has 12 different state transition sequences.

14. The apparatus of claim 13 wherein in each state the write state machine generates an output signal having a binary value equal to the Gray encoded binary value of that state, wherein the output signal determines the address in the memory to which an associated 4 bytes of the cell are stored.

15. The apparatus of claim 14 wherein in each state the read state machine generates an output signal having a binary value equal to the Gray encoded binary value of that state, wherein the output signal determines the address in the memory from which an associated 4 bytes of the cell are retrieved.

16. The apparatus of claim 15 wherein the memory is selected from a group consisting of a static random access memory, a dynamic random access memory, a non-volatile memory and a register file.

17. The apparatus of claim 16 wherein the cell is an ATM cell.

18. A method for converting a cell having a plurality of data bytes from a first format to a second format, the cell including a plurality of data bytes, the method comprising:
applying a plurality of signals to write circuitry to store the plurality of data bytes of the cell in a memory in accordance with the first format; and thereafter
applying a second plurality of signals to read circuitry to retrieve associated bytes of the stored plurality of data bytes of the cell from the memory in accordance with the second format; wherein
said first plurality of signals do not include any of said second plurality of signals; and wherein
said second plurality of signals do not include any of said first plurality of signals.

19. The method of claim 18 wherein the write circuitry includes a write state machine and wherein the read circuitry includes a read state machine.

20. The method of claim 19 wherein the write and read state machines have identical state transitions.

21. The method of claim 20 further comprising:
Gray-encoding the states of each of the write and the read state machines.

22. The method of claim 21 further comprising:
storing each successive n bytes of the cell in a different address location of the memory, wherein n is an integer varying between 1 and 32.

23. The method of claim 22 wherein n is equal to 4.

24. The method of claim 23 wherein the first plurality of signals define lengths of prepend, postpend and HEC fields of the first format of the cell.

25. The method of claim 24 wherein the second plurality of signals define lengths of prepend, postpend and HEC fields of the second format of the cell.

26. The method of claim 25 wherein the first plurality of signals define the sequence of state transitions of the write state machine.

27. The method of claim 26 wherein the second plurality of signals define the sequence of state transitions of the read state machine.

28. The method of claim 27 wherein the write and read state machines transition through the same sequence of states if the lengths of prepend, postpend and HEC fields of the first and second format of the cell are the same.

29. The method of claim 28 wherein the sum of the lengths of prepend and postpend fields in each of the first and second cell formats is up to 2 words and the length of HEC field in each of the first and second cell formats is up to 1 word.

30. The method of claim 29 wherein each of write and read state machines has 12 different state transition sequences.

31. The method of claim 30 wherein in each state the write state machine generates an output signal having a binary value equal to the Gray encoded binary value of that state, wherein the output signal determines the address in the memory to which an associated 4 bytes of the cell are stored.

32. The method of claim 31 wherein in each state the read state machine generates an output signal having a binary value equal to the Gray encoded binary value of that state, wherein the output signal determines the address in the memory from which an associated 4 bytes of the cell are retrieved.

33. The method of claim 32 wherein the memory is selected from a group consisting of a static random access memory, a dynamic random access memory, a non-volatile memory and a register file.

34. The method of claim 33 wherein the cell includes 53 bytes.

35. The method of claim 34 wherein the cell is an ATM cell.
